(19) United States
(12) Patent Application Publication
(10) Pub. No.: US 2024/0020663 A1
(43) Pub. Date: Jan. 18, 2024

(54) METHOD FOR FILLING AN ENERGY STORAGE DEVICE OF A MOTOR VEHICLE BY MEANS OF A CHARGING DEVICE, AS WELL AS A METHOD FOR OPERATING A CHARGING DEVICE FOR A MOTOR VEHICLE

(71) Applicant: MERCEDES-BENZ GROUP AG, Stuttgart (DE)

(72) Inventors: Jörg ECHARD, Sindelfingen (DE); Martin KEPPLER, Oberreichenbach (DE)

(21) Appl. No.: 18/030,088

(22) PCT Filed: Sep. 30, 2021
(86) PCT No.: PCT/EP2021/076903

§ 371 Date: Apr. 4, 2023

(30) Foreign Application Priority Data
Oct. 5, 2020 (DE) 10 2020 006 087.0

(51) Int. Cl. G06Q 20/10; B60L 53/66

(52) U.S. Cl. CPC G06Q 20/102; B60L 53/665

(57) ABSTRACT

A method for filling an energy storage device of a motor vehicle by a charging device involves the motor vehicle being closer to the charging device than a predetermined threshold distance. A billing account associated with the motor vehicle is provided with a clearly identifiable, wirelessly transmitted identifier for the charging device by an electronic computing device of the motor vehicle. The energy storage device is filled by the charging device, and in accordance with the filling and the billing account is automatically debited.

### BACKGROUND AND SUMMARY OF THE INVENTION

Exemplary embodiments of the invention relate to a method for filling an energy storage device of a motor vehicle by means of a charging device, as well as a method for operating a charging device for a motor vehicle.

DE 10 2018 214 986 A1 discloses a device for route planning for an electric vehicle. The device comprises an input interface for receiving a current state of charge of an energy storage device of the electric vehicle, as well as a planned route of the electric vehicle. The device furthermore comprises a database interface for receiving charging point information with positions of charging points. The device also has an energy planning unit for identifying an estimated trajectory of the state of charge of the energy store, based on the current state of charge of the energy store and the planned route. The device furthermore comprises a charge planning unit for selecting a charging point based on the estimated trajectory of the state of charge, the charging point information and the planned route. A customization unit of the device is furthermore configured to identify at least one customized route via the position of the selected charging point, based on the planned route. Furthermore, the device can have a booking unit for identifying an estimated time of arrival at the point where the vehicle runs out of charge and for booking the selected charging point at the estimated time of arrival. The booking unit is preferably a mobile communication unit for mobile communication with a booking service for managing charging time periods of charging points.

U.S. Pat. No. 9,371,007 discloses a method and systems that enable the automatic charging of vehicles by means of wireless charging pads, wherein a cloud system with one or more servers connected to the internet is used. The method comprises receiving an identification of an electric vehicle on a server, which is associated with a user account. The user account is pre-authorized to receive charging from a charging unit (CU) that is associated with a network of CUs. The method also comprises the receipt of data on the server that shows that the electric vehicle is at least partially situated over a charging pad of a CU of the network. The server sends data to the CU, so that the charging pad automatically transfers charging to the electric vehicle if the user account is pre-authorized.

Exemplary embodiments of the invention relate to a method for filling an energy storage device of a motor vehicle by means of a charging device, wherein as soon as the motor vehicle is arranged closer to the charging device than a predetermined threshold distance, an identifier is provided to the charging device by an electronic computing device of the motor vehicle, by means of wireless transmission. This identifier clearly identifies a billing account associated with the motor vehicle. An identification of the motor vehicle approaching the charging device or of the billing account associated with the motor vehicle approaching the charging device thus occurs. Here, the approach of the motor vehicle closer than the predetermined threshold distance from the charging device can be identified, for example by means of an approach sensor device. It is furthermore provided in the method that the energy storage device is filled by means of the charging device. The energy storage device can hereby be filled with a defined amount of an energy source by means of the charging device. The billing account is automatically debited in accordance with the filling. This means that a sum representing the amount of the energy source filled into the energy storage device by means of the charging device is debited from the billing account. In the method, a wireless payment of the filling process thus occurs, prompted by the approach of the motor vehicle to the charging device. A separate approval of the payment for the filling process can hereby be omitted. The described method enables a filling process of the energy storage device of the motor vehicle that is especially convenient for a user, wherein the filling process can be paid for especially simply, quickly, and automatedly.

In order to debit the billing account for the filling, according to the invention a defined amount of electrical energy is received from the charging device by means of the energy storage device of the motor vehicle and the billing account is automatically debited with a sum representing the transferred amount of electrical energy, wherein the sum is automatically debited from the billing account identified by means of the identifier.

In an advantageous development of the invention, it is provided that by means of the charging device, a battery of the motor vehicle, as an energy storage device, is loaded with a defined amount of electrical energy and the billing account is debited in accordance with the transferred amount of electrical energy. The motor vehicle is, in particular, an electrically operable motor vehicle, which can be driven with electrical energy from the battery. The battery is, in particular, a high-voltage battery. The charging device can be an electrical charging point configured to provide electrical energy for charging the battery of the motor vehicle. The method thus allows that, during the filling process, in particular during a charging process of an electrical vehicle as a motor vehicle, the charging process, and in particular the payment of the charging process, can be especially conveniently carried out for a driver of the motor vehicle.

In a further embodiment of the invention, it has been shown to be advantageous if, by means of a navigation device of the motor vehicle, a route for the motor vehicle comprising at least one charging stop at the charging device is specified, wherein a charging device is selected for the charging stop, which is configured to wirelessly receive the identifier and to debit the billing account and/or to receive a reservation for the motor vehicle. The navigation device is, in particular, configured to receive a start input characterizing a start of a journey, as well as a destination input characterizing a destination of the journey from a user, in particular a vehicle occupant, in particular the driver of the motor vehicle, and to identify the route in accordance with the start input and the destination input. The navigation device can furthermore identify an energy consumption of the motor vehicle for the identified route. Depending on the identified energy consumption as well as an amount of energy received into the energy storage device of the motor vehicle and thus stored, the navigation device can identify whether at least one charging stop is necessary and/or how many charging stops are necessary and/or where respective charging stops should be provided for along respectively identified possible routes. The at least one charging stop at a respective charging device can hereby be selected in accordance with whether, at the respective charging device provided at the respective charging stop, the identification of the billing account when the motor vehicle approaches the charging device and contactless payment and/or receiving a reservation for the motor vehicle are possible. An especially convenient route for the driver of the motor vehicle can hereby be identified with the at least one charging stop, at which the energy storage device of the motor vehicle can be filled with the energy source especially conveniently and simply for the driver of the motor vehicle, and the respective filling process can be paid for.

It has been shown to be especially advantageous in this context if the selected charging device is reserved by means of the navigation device. This means that a reservation signal characterizing the desired reservation is provided by the navigation device for the selected charging device. When receiving the reservation signal provided by the navigation device, a predetermined time interval characterized by the reservation signal can be reserved by the charging device for the motor vehicle characterized by the reservation signal. The charging device can thus be kept free for the motor vehicle characterized by the reservation signal for the time interval characterized by the reservation. It can hereby be ensured that when the motor vehicle arrives at the charging device, the charging device is available for the motor vehicle and is thus free. The route for the motor vehicle can hereby be covered especially time-efficiently, since a long wait for the motor vehicle at the charging device until the charging device is free for the motor vehicle can be omitted due to the existing reservation. The route can hereby advantageously be covered especially quickly.

It has furthermore been shown to be especially advantageous in this context if the navigation device identifies an estimated time of arrival at the selected charging device several times and at regular intervals and provides the estimated time of arrival to the charging device. This means that the navigation device identifies an updated time of arrival at regular time intervals and informs the charging device of the updated time of arrival. The charging device can thereby include the respective updated estimated time of arrival of the motor vehicle when allocating respective charging capacities. Advantageously, a particularly large number of motor vehicles can hereby be successively charged or filled with the energy source by means of the charging device.

It has hereby been shown to be especially advantageous if the reservation of the charging device is adjusted depending on the expected time of arrival. If a time of arrival changes due to the regular updating of the time of arrival of the motor vehicle, then a respective freeing of a filling of an energy storage device of a further motor vehicle can be enabled or prevented in accordance with the updated estimated time of arrival, by means of the charging device. It can thus, on the one hand, be ensured that the charging device is free for the motor vehicle when the motor vehicle relating to the reservation arrives at the charging device at its estimated time of arrival and thus a filling of the energy storage device of the motor vehicle is possible, and, on the other hand, it can be enabled that a particularly large number of motor vehicles can be filled, in particular can be charged, with the energy source by means of the charging device, whereby the charging device can be operated especially efficiently.

The invention furthermore relates to a method for operating a charging device for a motor vehicle, wherein, by means of the charging device, an identifier is received from an electronic computing device of the motor vehicle. The identifier clearly identifies a billing account associated with the motor vehicle. The identifier is wirelessly received from the electronic computing device of the motor vehicle by means of the charging device as soon as the motor vehicle is arranged nearer relative to the charging device than a predetermined threshold distance. It is furthermore provided in the method that an energy storage device of the motor vehicle is filled by means of the charging device. The charging device therefore provides an energy source or electrical energy for the energy storage device of the motor vehicle. The energy storage device of the motor vehicle is in particular a battery, in particular a high-voltage battery of the motor vehicle, which is, in particular, electrically drivable. It is thereby provided in the method that a defined amount of an energy source or a defined amount of electrical energy is provided for the motor vehicle by means of the charging device and is, in particular, charged or transferred into the energy storage device of the motor vehicle. It is furthermore provided in the method that the billing account is automatically debited in accordance with the filling, in particular in accordance with the defined amount of electrical energy provided by means of the charging device. A further authorization of a billing process by the driver of the motor vehicle for a respective filling process of the energy storage device can thereby be omitted. A filling process, in particular a charging process, can thus be paid for especially simply and conveniently for a driver of the motor vehicle. A sum of money characterizing the amount of the energy source provided or transferred from the charging device to the energy storage device of the motor vehicle can be authorized solely on the basis of the identified approach of the motor vehicle closer to the charging device than the predetermined threshold distance. The payment process is thus especially simple, convenient, safe, and reliable, both for the driver of the motor vehicle and also for an operator of the charging device.

In a further embodiment of the invention, it has been shown to be advantageous if an availability of the charging device is identified and, depending on the identified availability, access to the charging device is cleared or prevented for the motor vehicle. This means that a physical access of the motor vehicle to the charging device is cleared if it is determined that the charging device is available for the motor vehicle, whereas the physical access of the motor vehicle to the charging device is prevented and thus blocked if it is determined that the charging device is not available for the motor vehicle. If the access of the motor vehicle to the charging device is prevented, the motor vehicle can, for example, be redirected to a car park. Therefore, motor vehicles are only allowed to approach the charging device that can be filled with the energy source or the electrical energy at a respective current point in time by means of the charging device due to the availability of the charging device. An overcrowding of the charging device can thus be advantageously avoided.

It has hereby been shown to be especially advantageous if the availability is checked relative to existing reservations of the charging device. This means that it is checked by means of the charging device for which period of time or for which periods of time there are reservations and for which motor vehicles the charging device is reserved for the respective periods of time. When a respective motor vehicle arrives at the charging device, the charging device therefore checks whether there is a reservation of the charging device for a relevant time period and thus, if applicable, a time period that coincides with a filling process of the motor vehicle arranged at the charging device, or whether the charging device is available for the motor vehicle arranged at the charging device. The checking of the arrival of the motor vehicle thereby preferably occurs wirelessly, for example by means of a radio connection. If it is determined that there is a reservation for the relevant time period for a possible filling of the motor vehicle arranged at the charging device with the energy source, then it is checked which motor vehicle is associated with the existing reservation. If the existing reservation is associated with the motor vehicle that is arranged at the charging device, then the motor vehicle arranged at the charging device is authorized to access the charging device. This authorization also occurs wirelessly. If it is detected that the existing reservation that coincides with the relevant period of time is not associated with the motor vehicle arranged at the charging device, then the motor vehicle arranged at the charging device can be denied access to the charging device. Alternatively, the motor vehicle arranged at the charging device can be allowed to access the charging device until a break in a time interval represented by the reservation. Respective reservations as well as filling processes of energy storage devices of motor vehicles arranged at the charging device can thus be especially advantageously coordinated.

In further embodiments of the invention, it has been shown to be advantageous if, by means of the charging device, a reservation for the motor vehicle is received, a match between the motor vehicle characterized by the reservation and the motor vehicle characterized by the identifier is identified when receiving the wirelessly transmitted identifier, and when the match is submitted, access to the charging device is cleared for the motor vehicle. This means that, by means of the charging device, the access to the charging device is cleared for the motor vehicle approaching closer to the charging device than the predetermined threshold distance, provided that the reservation for the motor vehicle characterized by the identifier provided by the motor vehicle exists. It can hereby be ensured that motor vehicles for which there is a reservation can be filled with the energy source, in particular the electrical energy, at respectively reserved time periods, by means of the charging device.

Further advantages, features, and details of the invention result from the description of preferred exemplary embodiments below, as well as by means of the drawing(s). The features and feature combinations referred to in the description, as well as the features and feature combinations referred to below in the description of the figures and/or shown solely in the figures can be used not only in each specified combination but also in other combinations or alone, without leaving the scope of the invention.

### BRIEF DESCRIPTION OF THE DRAWING FIGURES

Here are shown:

FIG. 1 a schematic perspective view of a motor vehicle arranged at a charging device, the energy storage device of which is charged by means of electrical energy from the charging device and which provides a wirelessly transmitted identifier for the charging device, by means of which a billing account that can be associated with the motor vehicle can be clearly identified, wherein the billing account can be debited by the charging device in accordance with an amount of electrical energy transferred from the charging device to the motor vehicle;

FIG. 2 a process diagram for a method for filling the energy storage device of the motor vehicle by means of the charging device; and

FIG. 3 a process diagram for a method for operating a charging device for a motor vehicle.

### DETAILED DESCRIPTION

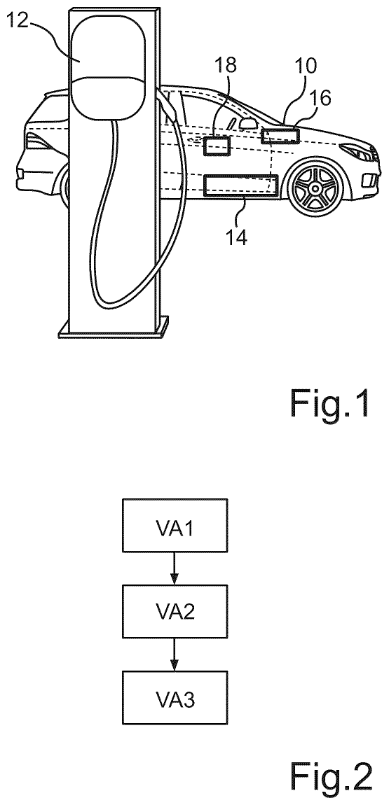

FIG. 1 illustrates a motor vehicle 10 and a charging device 12. The charging device 12 and the motor vehicle 10 can be connected with each other, whereby, by means of the charging device 12, an energy storage device 14 of the motor vehicle 10, represented schematically with a square, can be filled. The energy storage device 14 is preferably formed as a battery, in particular as a high-voltage battery. By means of the energy storage device 14, electrical energy for an electrical drive train of the motor vehicle 10 can be provided, whereby the motor vehicle 10 can be electrically driven by means of electrical energy from the energy storage device 14. The charging device 12 is configured to provided electrical energy, by means of which the energy storage device 14 of the motor vehicle 10 can be charged.

The motor vehicle 10 has an electronic computing device 16, which is here also shown schematically, as a box. The electronic computing device 16 is configured to wirelessly provide a clear identifier for the charging device 12. The electronic computing device 16 is, in particular, configured to provide the identifier for the charging device 12 as soon as it has been detected that the motor vehicle 10 is arranged at more than a predetermined threshold distance relative to the charging device 12. A respective distance of the motor vehicle 10 to the charging device 12 can, in particular. be identified by means of a position comparison of the motor vehicle 10 with the charging device 12 or by means of an approach sensor. This approach sensor can be a part of the charging device 12 or a part of the motor vehicle 10. For the position comparison, the electronic computing device 16 and the charging device 12 can swap data, which characterizes respective positions of the motor vehicle 10 and/or of the computing device 12, whereby, by means of the electronic computing device 16 and/or by means of the charging device 12, a respective distance between the motor vehicle 10 and the charging device 12 can be identified. As soon as it is identified that the motor vehicle 10 is arranged closer than the predetermined threshold distance from the charging device 12, the identifier for the charging device 12 is wirelessly provided by means of the electronic computing device 16. By means of the identifier, a billing account associated with the motor vehicle 10 is clearly identified. The charging device 12 can thus be informed of the billing account associated with the motor vehicle 10, as a result of receiving the identifier. The billing account can automatically be debited with a sum representing the amount of electrical energy transferred from the charging device 12 to the energy storage device 14 of the motor vehicle 10. This means that the sum representing the amount of electrical energy provided by the charging device 12 for the energy storage device 14 of the motor vehicle 10 can be automatically debited from the billing account identified by means of the identifier. A payment process for the amount of electrical energy transferred from the charging device 12 to the motor vehicle 10 can hereby occur especially simply and quickly.

FIG. 2 illustrates a process diagram for a method for filling the energy storage device 14 of the motor vehicle 10 by means of the charging device 12. As soon as it has been identified that a current distance between the motor vehicle 10 and the charging device 12 is smaller than the predetermined threshold distance, the clear identifier that identifies the billing account associated with the motor vehicle 10 is provided for the charging device 12 over a wireless connection in a first method step VA1, by means of the electronic computing device 16. In a second method step VA2, a defined amount of electrical energy is received from the charging device 12 by means of the energy storage device 14 of the motor vehicle 10. In a third method step VA3, a sum of money representing the amount of electrical energy transferred from the charging device 12 to the energy storage device 14 is identified and is automatically debited from the billing account identified by the identifier. A confirmation for the debiting of the sum of money by a driver of the motor vehicle 10 can hereby be omitted.

In order to be able to move the motor vehicle 10 along a route from a start point to a destination point especially time-efficiently, the motor vehicle 10 can have a navigation device 18, by means of which the route from the start point to the destination point can be identified for the motor vehicle 10. The navigation device 18 is also preferably schematically marked with a box. In particular for a route, the energy requirement of which exceeds an amount of energy stored or retained in the energy storage device 14 of the motor vehicle 10, at least one charging stop at a charging device 12, in particular the charging point, should be planned into the route by means of the navigation device 18. The charging stop can, to this end, be provided at one of several charging devices 12, which is configured to receive the identifier. Furthermore, from the several charging devices 12, the charging device 12 for the charging stop can be selected, which is configured to automatically debit the billing account identified by the identifier with the sum representing the amount of electrical energy transferred from the charging device 12 to the energy storage device 14. Furthermore, for the at least one charging stop, the charging device 12 that is configured to receive a reservation representing the motor vehicle 10 from the navigation device 18 of the motor vehicle 10 can be selected from the several charging devices 12. The reservation, in particular a reservation signal representing the reservation, thereby characterizes a charging starting time predetermined by an estimated time of arrival of the motor vehicle 10 at the charging device 12 as well as an estimated duration of charging which is needed in order to transfer a predetermined amount of electrical energy from the charging device 12 to the energy storage device 14 of the motor vehicle 10. After selecting the route for the motor vehicle 10 by means of the navigation device 18, the selected charging device 12 can be reserved by means of the navigation device 18. To this end, the navigation device 18 can provide the reservation signal characterizing the reservation for the charging device 12. This reservation signal provided for the charging device 12 can, in particular, characterize an estimated time of arrival of the motor vehicle 10 at the charging device 12 as well as a required amount of energy for the energy storage device 14 of the motor vehicle 10 or an estimated charging time for the energy storage device 14 of the motor vehicle 10. Due to receiving the reservation signal, the charging device 12 can be reserved for the motor vehicle 10, for the estimated charging time predetermined by the reservation signal or identified in accordance with the received reservation signal, from the estimated time of arrival of the motor vehicle 10 at the charging device 12. By means of the navigation device 18, an updated reservation signal can be provided for the charging device 12 several times and at regular intervals, which characterizes a respective updated estimated time of arrival for the motor vehicle 10 at the charging device 12. Due to receiving the respective current reservation signal, the respective reservation for the motor vehicle 10 at the updated estimated time of arrival can be adjusted by means of the charging device 12. The charging device 12 can thereby be provided for a further motor vehicle through a time interval lying outside the reservation time span for the motor vehicle 10, whereby an especially advantageous capacity utilization can be achieved for the charging device 12.

The transmission of the identifier occurs wirelessly, with the help of a radio method. A short-range radio method (e.g., microwave radio or Bluetooth) or a long-range radio method, e.g., a data transmission over a mobile radio network, can be used. Short-range radio is preferably used when the motor vehicle 10 is approaching the charging device 12. Short-range radio can thereby serve for radio-based identification of the motor vehicle 10 at the charging point. Short-range radio can, however, also be used for identifying the distance between motor vehicle 10 and charging device 12 and, in this case, replaces the approach sensor. A long-range radio method can be used if a charging device 12 is reserved in advance.

A clear identifier of a short-range radio device should, in particular, also be able to be used as an identifier. A reservation of a charging device 12 would then therefore be made by the navigation device 18 over the mobile radio data network at a time of arrival for a dedicated motor vehicle 10, which identifies itself as the “correct” vehicle by means of the clear identifier from its short-range radio device.

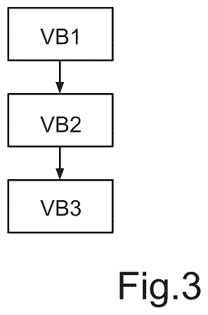

In FIG. 3, a process diagram for a method for operating the charging device 12 is shown. In a first method step VB1, the wirelessly transmitted identifier that clearly identifies the billing account associated with the motor vehicle 10 is received from the electronic computing device 16 of the motor vehicle 10 by means of the charging device 12. In a second method step VB2, a defined amount of electrical energy is provided for the energy storage device 14 of the motor vehicle 10 and the energy storage device 14 is thus charged with the defined amount of electrical energy by means of the charging device 12. In a third method step VB3, a sum of money corresponding to the amount of electrical energy provided for the energy storage device 14 is identified, and the billing account clearly identified by means of the identifier is debited with the identified amount of money. An especially simple and convenient payment for a filling process of the energy storage device 14 of the motor vehicle 10 hereby occurs by means of the charging device 12.

If the motor vehicle 10 approaches the charging device 12, then an availability of the charging device 12 for the motor vehicle 10 can be identified by means of the charging device 12 and, depending on the identified availability, access to the charging device 12 is cleared or prevented for the motor vehicle 10. In the context of the checking of the availability, it can be identified whether and for what time period a reservation of the charging device 12 exists. It can furthermore be checked whether an existing reservation of the charging device 12 is associated with the motor vehicle 10. If it is identified that there is no reservation for a relevant charging time of the motor vehicle 10 approaching the charging device 12 or an existing reservation is to be associated with the motor vehicle 10 approaching the charging device 12, then the access to the charging device 12 is cleared and thus allowed for the motor vehicle 10. If it is identified that there is a reservation for a relevant charging time of the motor vehicle 10 approaching the charging device 12 that is associated with a motor vehicle that is different to the motor vehicle approaching the charging device 12, then the motor vehicle 10 approaching the charging device 12 is denied access to the charging device 12. In particular, the reservation for the motor vehicle 10 can be received by means of the charging device 12, and a match between the motor vehicle 10 characterized by the reservation and the motor vehicle 10 characterized by the identifier is identified when receiving the identifier from the motor vehicle 10. If the match exists, then the charging device 12 clears the access for the motor vehicle 10. If the match does not exist, then the charging device 12 prevents the access of the motor vehicle 10 to the charging device 12.

The navigation device 18 arranged in the motor vehicle 10 can identify a current likely time of arrival at an intended charging device 12 at any time and make it available to the charging device 12 and/or a higher level electronic computing device, in particular a server device, which can also be referred to as a back-end service. The motor vehicle 10 furthermore comprises the electronic computing device 16, which can be part of a wireless payment system and which provides the clear identifier for identification of the billing account and for billing a service, here the filling process, over a wireless connection when it approaches a payment device. In the context of planning a charging stop along the route, a piece of information can be accessed that characterizes which charging devices 12 enable billing via the wireless payment system. These charging devices 12 that allow billing via the wireless payment system can hereby be saved in the higher level server device and can be provided by this for the navigation device 18 and/or saved in the motor vehicle 10. In the context of planning a charging stop it is furthermore known which of the charging devices 12 enable an advance booking via the wireless payment system. Information about which charging devices 12 enable an advance booking via the wireless payment system can be saved in the higher level server device and can be provided for the navigation device 18 of the motor vehicle 10 and/or can be saved in the motor vehicle 10.

For charging devices 12 that enable a payment via the described wireless payment system, a spontaneous charging without strategic charging planning can be shown as follows: when the motor vehicle 10 spontaneously arrives at the charging device 12, registration, approval and payment of the filling process automatically occur without further user interaction, since the motor vehicle 10 can be automatically identified when it approaches the charging device 12 by means of the clear identifier, which is transmitted wirelessly, and the described billing process can be used via the billing account.

With strategic charging planning when selecting the route by means of the navigation device 18, the charging and payment process occurs as follows: For charging devices 12 that allow a payment via the wireless payment system, a payment is automatically pre-set for the corresponding charging device 12 by means of the wireless payment system via the server device, in particular the back-end service, and the clear identifier is transmitted to an operator of the at least one charging device 12. Registration, approval, and payment of the filling process then occur automatically without further user interaction, as soon as the motor vehicle 10 has provided the identifier for the charging device 12 and the energy storage device 14 of the motor vehicle 10 has been charged by means of the charging device 12, since the motor vehicle 10 can be automatically identified by means of the clear identifier when it drives up to the charging device 12. With strategic charging planning, an advance booking of the charging device 12 can furthermore be carried out for the specific motor vehicle 10. Here, the charging device 12 can already independently automatically identify whether there is a reservation for the arriving motor vehicle 10, when the motor vehicle 10 arrives. When there is a reservation, the access to the charging device 12 can then be cleared for the motor vehicle 10. Motor vehicles 10 without this reservation obtain this access according to availability and can be redirected to a car park if the charging device 12 is not available.

By means of interaction between the navigation device 18, the higher level server device, and the charging device 12, a dynamic reservation can be implemented to the effect that a delay in a journey of the motor vehicle 10 to the charging device 12 or an earlier arrival of the motor vehicle 10 to the charging device 12 than had been identified in the original identification of the route for the motor vehicle 10 is automatically applied to the reservation of the motor vehicle 10 for the charging device 12. This enables an optimal capacity utilization of the charging device 12 and an especially reliable charging planning, as well as an especially advantageous charging experience for a driver of the motor vehicle 10. An especially advantageous capacity utilization of the charging device 12 is thus enabled since, if a motor vehicle 10 having a reservation is delayed and arrives around 30 minutes late, then, during these 30 minutes, a further motor vehicle can be charged by means of the charging device 12. The especially advantageous charging experience can furthermore be implemented, since the driver can be sure that their reservation then also exists if a traffic jam changes their journey plan. The charging device 12 can independently detect an arrival of the motor vehicle 10 and direct the latter, in particular to a reserved charging device 12. The charging device 12 can independently detect an arrival of the motor vehicle 10 and carry out registration, approval, and payment of a filling process of the motor vehicle 10 without interaction by the driver of the motor vehicle 10.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for filling an energy storage device of a motor vehicle by a charging device, the method comprising:
determining that the motor vehicle is closer to the charging device than a predetermined threshold distance, wherein responsive to determining that the motor vehicle is closer to the charging device than the predetermined threshold difference
providing, by the motor vehicle to the charging device using a wireless transmission, an identifier identifying a billing account associated with the motor vehicle is provided to the charging device,
filling the energy storage device by the charging device, and
automatically debiting the billing account based on the filling, wherein a defined amount of electrical energy is received from the charging device by the energy storage device and the billing account is automatically debited with a sum representing the transferred amount of electrical energy, and wherein the sum is automatically debited from the billing account identified by the identifier.

12. The method of claim 11, wherein the energy storage device is a battery of the motor vehicle, wherein the battery is loaded by the charging device with a defined amount of electrical energy and the billing account is debited in accordance with the transferred amount of electrical energy

13. The method of claim 11, further comprising:
specifying, by a navigation device of the motor vehicle, a route for the motor vehicle comprising at least one charging stop at the charging device; and
selecting a charging device for the charging stop, wherein the selected charging device is configured to wirelessly receive the identifier and to debit the billing account or is configured to receive a reservation for the motor vehicle.

14. The method of claim 13, wherein the selected charging device is reserved by the navigation device.

15. The method of claim 14, wherein the navigation device identifies an estimated time of arrival at the selected charging device several times and at regular intervals and provides the estimated time of arrival to the charging device.

16. The method of claim 15, wherein the reservation of the charging device is adjusted depending on the estimated time of arrival.

17. A method for operating a charging device for a motor vehicle, the method comprising:
receiving, from the motor vehicle by the charging device, a wirelessly transmitted identifier identifying a billing account associated with the motor vehicle as soon as the motor vehicle is closer to the charging device than a predetermined threshold distance;
filling, by the charging device, an energy storage device of the motor vehicle; and
automatically debiting the billing account in accordance with the filling.

18. The method of claim 17, further comprising:
identifying an availability of the charging device; and
clearing access to the charging device for the motor vehicle depending on the identified availability.

19. The method of claim 18, wherein the availability is checked relative to existing reservations of the charging device.

20. The method of claim 17, wherein the charging device receives a reservation for the motor vehicle, a match between the motor vehicle associated with the reservation and the motor vehicle associated with the identifier is identified when receiving the wirelessly transmitted identifier, and when the match is submitted, access to the charging device is cleared for the motor vehicle.
